(19) United States
(12) Patent Application Publication
(10) Pub. No.: US 2025/0001522 A1
(43) Pub. Date: Jan. 2, 2025

(54) WELDING OF STACKS OF EXTERNAL TABS OF ELECTRODES TO TERMINALS WITH TWO STEP LASER PROCESS THAT REDUCES DEFECTS

(71) Applicant: GM GLOBAL TECHNOLOGY OPERATIONS LLC, Detroit, MI (US)

(72) Inventors: Teresa Jean RINKER, Royal Oak, MI (US); Masoud Mohammadpour, Novi, MI (US); Junjie Ma, Novi, MI (US); Chih-Chang Chen, Rochester Hills, MI (US)

(21) Appl. No.: 18/343,456

(22) Filed: Jun. 28, 2023

(51) Int. Cl. B23K 26/21; H01M 50/566

(52) U.S. Cl. CPC B23K 26/21; H01M 50/566

(57) ABSTRACT

A method for joining external tabs of a battery cell to a terminal includes providing a battery cell stack including C cathode electrodes, A anode electrodes, and S separators, where C, S and A are integers greater than one. The method includes arranging a stack of external tabs of one of the C cathode electrodes and the A anode electrodes on a terminal; creating a trench in the stack of external tabs of the one of the C cathode electrodes and the A anode electrodes at a weld location during a first laser processing step; and welding the stack of external tabs of the one of the C cathode electrodes and the A anode electrodes at the weld location during a second laser processing step.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to laser welding of stacks of external tabs of electrodes to terminals of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A method for joining external tabs of a battery cell to a terminal includes providing a battery cell stack including C cathode electrodes each including a cathode current collector made of foil, a cathode active layer arranged on the cathode current collector, and an external tab extending from the cathode current collector, A anode electrodes including an anode current collector made of foil, an anode active layer arranged on the anode current collector, and an external tab extending from the anode current collector, and S separators, where C, S and A are integers greater than one. The method includes arranging a stack of external tabs of one of the C cathode electrodes and the A anode electrodes on a terminal; creating a trench in the stack of external tabs of the one of the C cathode electrodes and the A anode electrodes at a weld location during a first laser processing step; and welding the stack of external tabs of the one of the C cathode electrodes and the A anode electrodes at the weld location during a second laser processing step.

In other features, the first laser processing step and the second laser processing step are both performed using a first laser. The method includes adjusting at least one of laser power, laser scan speed, laser focus/defocus, laser oscillation pattern, workpiece speed, pulse frequency, and/or pulse shape of the first laser for the second laser processing step after the first laser processing step is performed. The first laser processing step and the second laser processing step are performed using a first laser and a second laser, respectively. The first laser is operated using different laser operating parameters than the second laser. At least one of laser power, laser scan speed, laser focus/defocus, workpiece speed, laser oscillation pattern, pulse frequency, and/or pulse shape of the second laser is different than the first laser.

In other features, the first laser is operated at a first focus setting and a first scan speed and the second laser is operated at a second focus setting and a second scan speed. The first focus setting is less focused than the second focus setting, and the first scan speed is higher than the second scan speed. At least some defects created during the first laser processing step are repaired during the second laser processing step.

In other features, the first laser comprises a cutting laser and the second laser comprises a welding laser. The first laser comprises a welding laser and the second laser comprises a welding laser. The method includes arranging fill material in the trench after the first laser processing step and prior to the second laser processing step.

A method for joining external tabs of a battery cell to a terminal includes providing a battery cell stack including C cathode electrodes each including a cathode current collector made of foil, a cathode active layer arranged on the cathode current collector, and an external tab extending from the cathode current collector, A anode electrodes including an anode current collector made of foil, an anode active layer arranged on the anode current collector, and an external tab extending from the anode current collector, and S separators, where C, S and A are integers greater than one. The method includes arranging a stack of external tabs of one of the C cathode electrodes and the A anode electrodes on a terminal; using a first laser, creating a trench in the stack of external tabs of the one of the C cathode electrodes and the A anode electrodes at a weld location during a first laser processing step; and using a second laser, welding the stack of external tabs of the one of the C cathode electrodes and the A anode electrodes at the weld location during a second laser processing step.

In other features, the first laser and the second laser are operated using at least one different laser operating parameter. The at least one different laser operating parameter is selected from a group consisting of laser power, laser scan speed, laser focus/defocus, workpiece speed, pulse frequency, and pulse shape.

In other features, the first laser comprises a cutting laser and the second laser comprises a welding laser. The first laser comprises a welding laser and the second laser comprises a welding laser. The first laser is operated at a first focus setting and a first scan speed and the second laser is operated at a second focus setting and a second scan speed.

In other features, the first focus setting is less focused than the second focus setting. The first scan speed is higher than the second scan speed. At least some defects created by the first laser during the first laser processing step are repaired by the second laser during the second laser processing step.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side cross sectional view of an example of a battery cell including cathode electrodes, anode electrodes, and separators according to the present disclosure;

FIG. 1B is a side view of an example of a pouch battery cell according to the present disclosure;

FIG. 1C is a perspective view of an example of a prismatic battery cell according to the present disclosure;

FIG. 1D is a side cross sectional view of an example of internal and external terminals of a prismatic battery cell according to the present disclosure;

FIG. 2 is a side view of an example of external tabs of the electrodes arranged on a terminal of a battery cell according to the present disclosure;

FIG. 3 is a side view illustrating an example of a first laser processing step for laser welding the stack of external tabs of the electrodes to the terminal of the battery cell according to the present disclosure;

FIG. 4 is a side view illustrating an example of defects in a trench at a weld location after the first laser processing step according to the present disclosure;

FIG. 5 is a side view illustrating an example of a second laser processing step for laser welding the stack of external tabs of the electrodes to the terminal of the battery cell according to the present disclosure;

FIG. 6 is a side view of an example of the stack of external tabs and the terminal after the second laser processing step according to the present disclosure;

FIG. 7 is a side view of another example of laser welding of the stack of external tabs to a terminal of a battery cell according to the present disclosure;

FIG. 8 is a side view illustrating another example of a first laser processing step for laser welding the stack of external tabs to the terminal of the battery cell according to the present disclosure;

FIG. 9 is a side view illustrating another example of defects in a trench at a weld location after the first laser processing step according to the present disclosure; and

FIG. 10 is a side view illustrating another example of a second laser processing step for laser welding the stack of external tabs to the internal terminal of the battery cell according to the present disclosure.

In the drawings, reference numbers may be reused to identify similar and/or identical elements.

### DETAILED DESCRIPTION

While battery cells including laser welded internal terminals are shown in the context of electric vehicles, the battery cells including laser welded internal terminals can be used in stationary applications and/or other applications.

The present disclosure addresses quality issues of welds between external tabs extending from current collectors of anode and/or cathode electrodes and terminals of a battery cell. In some examples, the terminals are internal terminals of the battery cell that are in contact with external terminals of the battery cell in prismatic battery cells. In other words, the external terminals are in contact with the internal terminals that are laser welded to the external tabs of the cathode electrodes and/or anode electrodes. As can be appreciated, separate terminals are used to connect to the cathode and anode electrodes to external devices.

When welding multiple layers of external tabs (e.g., external tabs extending from current collectors made of foil) in a lap joint, the weld may be porous and detachments may occur at a boundary of fusion. When laser welding is used, defects can be created. The present disclosure relates to joining of the external tabs of the current collectors of anode and/or cathode electrodes to the terminals using two-step laser processing to reduce or eliminate defects and improve weld quality. In some examples, laser welding is performed without ultrasonic welding.

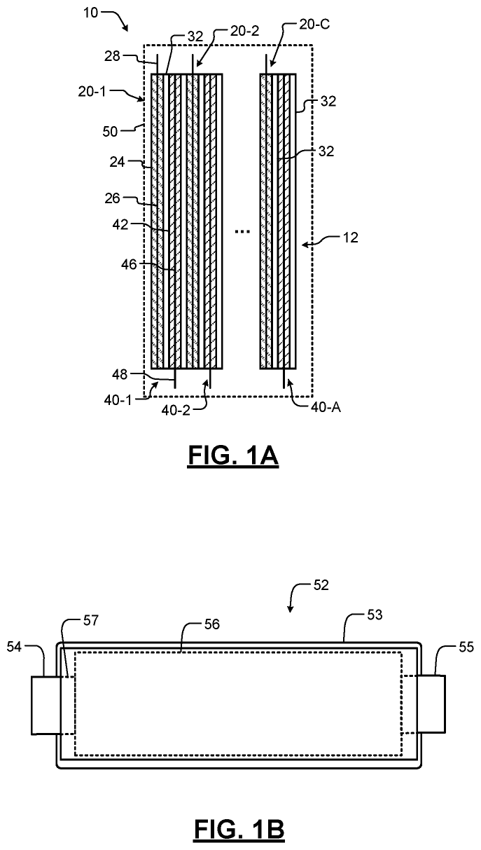

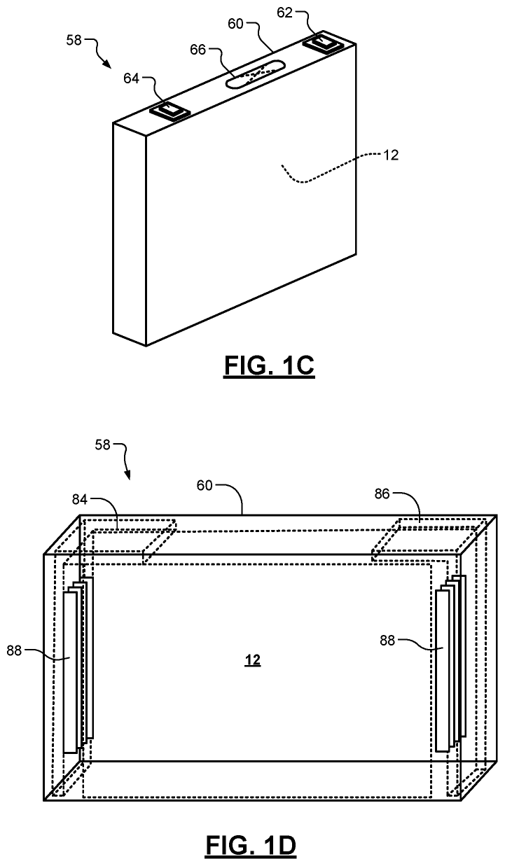

Referring now to FIG. 1A, a battery cell 10 includes C cathode electrodes 20, A anode electrodes 40, and S separators 32 arranged in a predetermined sequence in a stack 12 arranged in an enclosure 50. The cathode electrodes 20-1, 20-2, . . . , and 20-C (where C is an integer greater than one) include cathode active layers 24 arranged on one or both sides of cathode current collectors 26. The A anode electrodes 40-1, 40-2, . . . , and 40-A (where A is an integer greater than one) include anode active layers 42 arranged on one or both sides of the anode current collectors 46.

Connections to the C cathode electrodes 20 and the A anode electrodes 40 are typically made to terminals. The C cathode electrodes 20 and the A anode electrodes 40 include external tabs 28 and 48, respectively, that correspond to portions of the current collectors of the C cathode electrodes 20 and the A anode electrodes 40 that extend beyond the cathode and anode active material layers 24 and 42. In some examples, the external tabs 28 of the C cathode electrodes 20 are connected to an internal terminal and external tabs 48 of the A anode electrodes 40 are connected to another internal terminal. The internal terminals are connected to external terminals of the battery cell. While a length of the external tabs 28 and 48 is illustrated as relatively short in FIG. 1A, the external tabs 28 and 48 can extend any distance needed for welding or other purposes. The external tabs 28 and 48 can include a single external tab per electrode or multiple external tabs per electrode to provide a redundant connection. The external tabs 28 and 48 can extend the width of the current collectors or only a portion of the width of the current collectors.

In some examples, the cathode current collectors 26 and the anode current collectors 46 comprise foil layers. In some examples, the current collectors are made of one or more materials selected from a group consisting of copper, stainless steel, brass, bronze, zinc, aluminum, and alloys thereof. In some examples, the anode active layers 42 and/or the cathode active layers 24 comprise coatings including one or more active materials, one or more conductive fillers/additives, and/or one or more binder materials. In some examples, the battery cells and/or electrodes are manufactured by applying a slurry to coat the current collectors in a roll-to-roll manufacturing process.

Referring now to FIG. 1B, a pouch battery cell 52 includes a pouch enclosure 53 including a stack 56. As will be described further below, external tabs 57 of the anode and cathode electrodes are laser welded to terminals 54 and 55, respectively, that extend through the pouch enclosure 53.

Referring now to FIG. 1C, a prismatic battery cell 58 includes an enclosure 60. While a prismatic battery cell is shown for purposes of illustration, the two step laser processing according to the present disclosure can be used to laser weld the external tabs to terminals of cylindrical, pouch, or other battery cell form factors. In some examples, the enclosure 60 has rectangular cross-sections in x-, y- and z-axis planes. The prismatic battery cell 58 includes external terminals 62 and 64 and a vent cap 66. The stack 12 of the C cathode electrodes 20, the A anode electrodes 40, and the S separators 32 is arranged in the enclosure 60. As will be described further below, external tabs of the anode current collectors and/or the cathode current collectors are laser welded to the corresponding terminals. The terminals are arranged in contact with the external terminals 62 and 64 of the battery cell 10 to provide external connections to the anode electrodes and cathode electrodes.

Referring now to FIG. 1D, examples of internal terminals 84 and 86 of a prismatic battery cell are shown in the enclosure 60. The stack 12 of the A anode electrodes or the C cathode electrodes include external tabs 88. The external tabs 88 of the A anode electrodes and/or the C cathode electrodes are laser welded to the internal terminals 84 and 86, respectively, as will be described further below. While the internal terminals 84 and 86 are shown as “L”-shaped terminals, planar terminals or terminals having other shapes can be used.

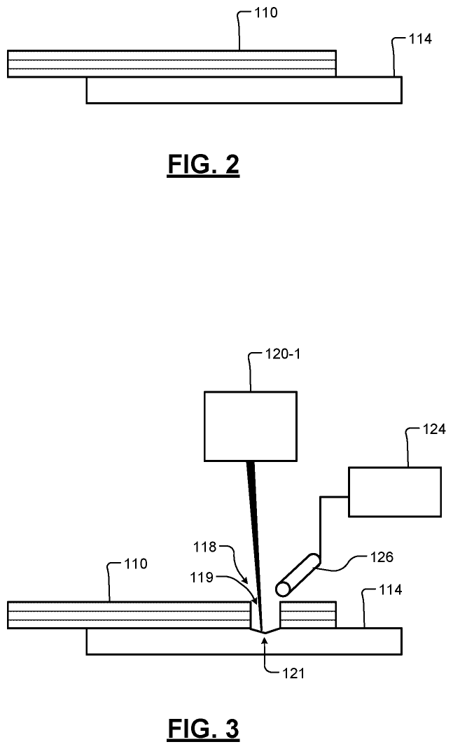

Referring now to FIGS. 2 to 4, an example of a first step of a two-step laser processing method is shown. As can be appreciated, the two-step laser processing method can be used to join the external tabs of the anode or cathode electrodes to terminals (e.g., in a prismatic battery cell or other types of battery cells). In FIG. 2, a stack of external tabs 110 extending from current collectors of either the cathode electrodes or the anode electrodes is arranged on a terminal 114 of a battery cell.

In FIG. 3, a laser 120-1 is directed onto a weld location 118 to create a trench 119 in the stack of external tabs 110. The laser 120-1 cuts and/or melts the stack of external tabs 110. In some examples, material may be removed at the weld location 118 of the stack of external tabs 110 to form the trench 119. In some examples, the laser 120-1 may also penetrate and/or remove a portion of the internal terminal 114 located below the weld location 118 as shown at 121. In some examples, a vacuum source 124 including a vacuum tube 126 can be used to remove melted foil, debris, or other material from the trench 119 formed at the weld location 118 during the first laser processing step to clean the weld location 118 prior to the second laser processing step.

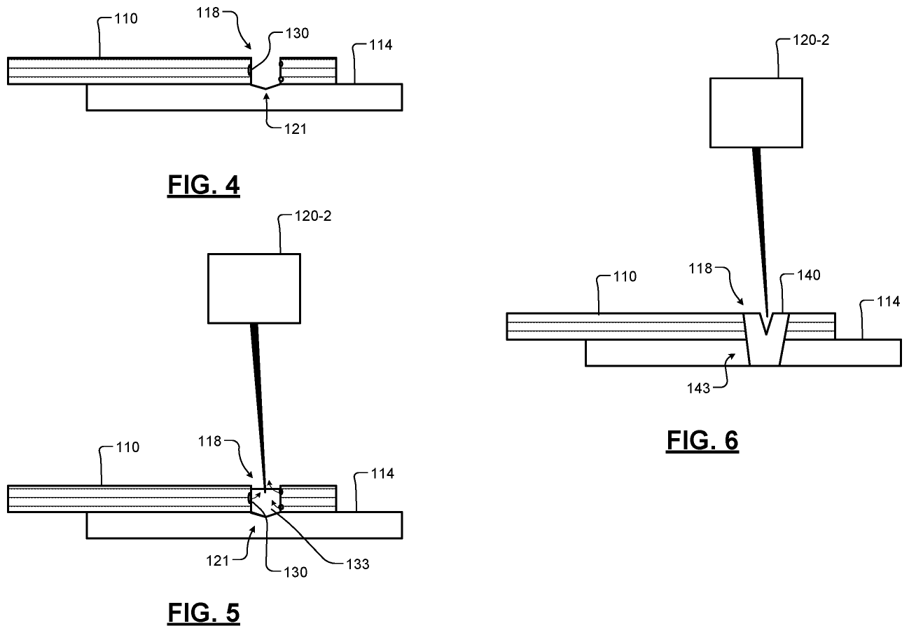

In FIG. 4, the stack of external tabs 110 is shown after the first laser processing step. Defects 130 such as voids or cracks may be formed on inner or outer surfaces of the stack of external tabs 110 inside and/or near the trench 119 formed at the weld location 118 during the first laser processing step. The defects are repaired during the second laser processing step.

Referring now to FIGS. 5 and 6, a second laser processing step is shown for welding the stack of the external tabs 110 of the anode or cathode electrode to the internal terminal of the battery cell. A laser 120-2 re-heats the weld location 118, the material melts, and the defects 130 are removed. The laser 120-2 heats an area slightly wider than the laser 120-1 and penetrates though some or all of the thickness of the terminal 114.

Prior to initiating the second laser processing step, the trench 119 at the weld location 118 may be at least partially filled with a weld fill material 133 that is compatible with the material of the foil and/or the internal terminal 114 being welded. The weld fill material 133 may be used to replace material lost during the first laser processing step. After the second laser processing step, the foil material, the internal terminal, the fill material, and/or the terminal reflows and a final weld 143 with few or no defects is created as shown in FIG. 6.

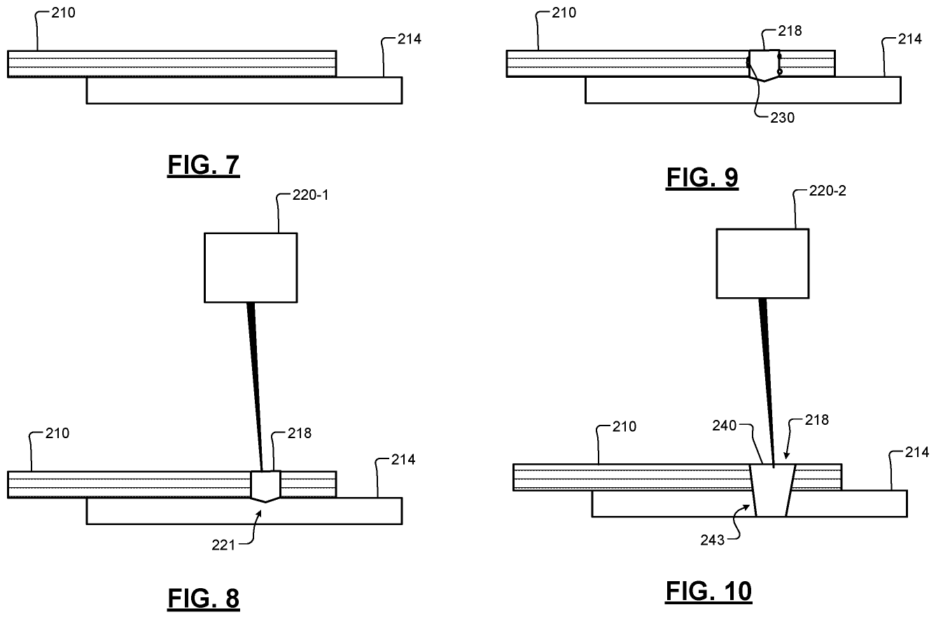

In some examples, the lasers 120-1 and 120-2 are the same laser. In some examples, the lasers 120-1 and 120-2 are different. For example, both of the lasers 120-1 and 120-2 may be welding lasers operated with different operating parameters. In other examples, the laser 120-1 is a cutting laser and the laser 120-2 is a welding laser. Examples of laser operating parameters include laser power, laser scan speed, laser oscillation pattern, laser focus/defocus, workpiece speed, pulse frequency, and/or pulse shape. The laser operating parameters are used to change the amount of heating that occurs in a given location. A laser oscillation pattern of the laser (e.g., such as a FIG. 8, a zig-zag pattern or other patterns) can be used adjust heating in the weld location.

As can be appreciated, the final weld is only slightly larger than the trench 119 created during the first laser processing step. Increasing the weld area during the second laser processing step remelts defects at edges of the weld location 118 and does not typically create new defects.

Referring now to FIGS. 7 to 9, a first laser processing step of another two-step laser processing method is shown. In FIG. 7, a stack 210 is arranged on an internal terminal 214 of a battery cell. In FIG. 8, a laser 220-1 heats material at a weld location 218. In some examples, the laser 120 penetrates a portion of the internal terminal 214 below the weld location 218. In FIG. 9, during the first laser processing step, a cavity is formed at the weld location 218 and material may be removed and/or defects 230 may be formed in the weld location 218.

Referring now to FIG. 10, a second laser processing step is shown for connecting the foil of the external tabs to the internal terminal of the battery cell. In some examples, a cavity at the weld location may be at least partially filled with weld fill material compatible with the foil prior to the second laser processing step. The laser 120 heats the weld location 218 and the defects 230 are removed. After further heating, a final weld 243 is created as shown in FIG. 10.

In some examples, the laser 220-1 and 220-2 corresponds to a single laser operated with the same or different operating parameters. In some examples, the lasers 220-1 and 220-2 are different and both are welding lasers. Examples of laser operating parameters include laser power, laser scan speed, laser oscillation pattern, laser focus/defocus, workpiece speed, pulse frequency, and/or pulse shape. In some examples, the laser 220-1 used during the first laser processing step uses a defocused laser beam and laser scanning at a first speed. In some examples, the laser 220-2 used during the second processing step uses a focused laser beam and laser scanning at a second speed that is slower than the first speed.

As can be appreciated, the final welds are only slightly larger than the trench 119 created during the first laser processing step. Increasing the weld area during the second laser processing step remelts defects and does not typically create new defects.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for joining external tabs of a battery cell to a terminal, comprising:
providing a battery cell stack including:
C cathode electrodes each including a cathode current collector made of foil, a cathode active layer arranged on the cathode current collector, and an external tab extending from the cathode current collector;
A anode electrodes including an anode current collector made of foil, an anode active layer arranged on the anode current collector, and an external tab extending from the anode current collector; and
S separators, where C, S and A are integers greater than one; and
arranging a stack of external tabs of one of the C cathode electrodes and the A anode electrodes on a terminal;
creating a trench in the stack of external tabs of the one of the C cathode electrodes and the A anode electrodes at a weld location during a first laser processing step; and
welding the stack of external tabs of the one of the C cathode electrodes and the A anode electrodes at the weld location during a second laser processing step.

2. The method of claim 1, wherein the first laser processing step and the second laser processing step are both performed using a first laser.

3. The method of claim 2, further comprising adjusting at least one of laser power, laser scan speed, laser focus/defocus, laser oscillation pattern, workpiece speed, pulse frequency, and/or pulse shape of the first laser for the second laser processing step after the first laser processing step is performed.

4. The method of claim 1, wherein the first laser processing step and the second laser processing step are performed using a first laser and a second laser, respectively.

5. The method of claim 4, wherein the first laser is operated using different laser operating parameters than the second laser.

6. The method of claim 5, wherein at least one of laser power, laser scan speed, laser focus/defocus, workpiece speed, laser oscillation pattern, pulse frequency, and/or pulse shape of the second laser is different than the first laser.

7. The method of claim 4, wherein the first laser is operated at a first focus setting and a first scan speed and the second laser is operated at a second focus setting and a second scan speed.

8. The method of claim 7, wherein:
the first focus setting is less focused than the second focus setting, and
the first scan speed is higher than the second scan speed.

9. The method of claim 1, wherein at least some defects created during the first laser processing step are repaired during the second laser processing step.

10. The method of claim 4, wherein the first laser comprises a cutting laser and the second laser comprises a welding laser.

11. The method of claim 4, wherein the first laser comprises a welding laser and the second laser comprises a welding laser.

12. The method of claim 1, further comprising arranging fill material in the trench after the first laser processing step and prior to the second laser processing step.

13. A method for joining external tabs of a battery cell to a terminal, comprising:
providing a battery cell stack including:
C cathode electrodes each including a cathode current collector made of foil, a cathode active layer arranged on the cathode current collector, and an external tab extending from the cathode current collector;
A anode electrodes including an anode current collector made of foil, an anode active layer arranged on the anode current collector, and an external tab extending from the anode current collector; and
S separators, where C, S and A are integers greater than one; and
arranging a stack of external tabs of one of the C cathode electrodes and the A anode electrodes on a terminal;
using a first laser, creating a trench in the stack of external tabs of the one of the C cathode electrodes and the A anode electrodes at a weld location during a first laser processing step; and
using a second laser, welding the stack of external tabs of the one of the C cathode electrodes and the A anode electrodes at the weld location during a second laser processing step.

14. The method of claim 13, wherein the first laser and the second laser are operated using at least one different laser operating parameter.

15. The method of claim 14, wherein the at least one different laser operating parameter is selected from a group consisting of laser power, laser scan speed, laser focus/defocus, workpiece speed, pulse frequency, and pulse shape.

16. The method of claim 13, wherein the first laser comprises a cutting laser and the second laser comprises a welding laser.

17. The method of claim 16, wherein the first laser comprises a welding laser and the second laser comprises a welding laser.

18. The method of claim 13, wherein the first laser is operated at a first focus setting and a first scan speed and the second laser is operated at a second focus setting and a second scan speed.

19. The method of claim 18, wherein:
the first focus setting is less focused than the second focus setting, and
the first scan speed is higher than the second scan speed.

20. The method of claim 13, wherein at least some defects created by the first laser during the first laser processing step are repaired by the second laser during the second laser processing step.
